(19) United States
(12) Patent Application Publication
(10) Pub. No.: US 2002/0159928 A1
(43) Pub. Date: Oct. 31, 2002

(54) Reforming apparatus and scavenging method for the same

(75) Inventors: Takahiro Naka, Wako-shi (JP); Masataka Furuyama, Wako-shi (JP); Shoji Isobe, Wako-shi (JP)

Correspondence Address: LAHIVE & COCKFIELD, 28 STATE STREET, BOSTON, MA, 02109, US

(73) Assignee: HONDA GIKEN KOGYO KABUSHIKI KAISHA, Tokyo (JP)

(21) Appl. No.: 10/093,236

(22) Filed: Mar. 6, 2002

(30) Foreign Application Priority Data
Mar. 8, 2001 (JP) P2001-065159

(51) Int. Cl. B01J 8/02

(52) U.S. Cl. 422/188; 422/211

(57) ABSTRACT

The present invention provides a reforming apparatus and a scavenging method for the reforming apparatus that simplifies the system for the operation stop of the apparatus without requiring an inert gas for scavenging and can limit the degradation of the catalyst. The present invention comprises a reformer 3 that generates a hydrogen rich gas from a fuel stream by a reforming reaction using a reforming catalyst, a fuel introducing device 4 that can introduce a fuel stream into a reformer 3, a selective oxidizing apparatus 12 that oxidizes carbon monoxide in the reformed gas into carbon dioxide by a selective oxidizing reaction using a selective oxidizing catalyst, and an air introducing device 5 that can introduce air into the reformer 3, and wherein the reforming catalyst of the reformer 3 is a noble metal catalyst carried by a metallic oxide, and the selective oxidizing catalyst of the selective oxidizing apparatus 12 is a catalyst that incorporates platinum.

### BACKGROUND OF THE INVENTION

1. Field of the Invention

The present invention relates to a reforming apparatus that generates a reformed gas that includes hydrogen from a fuel stream that includes an alcohol or hydrocarbons and water, and in particular to a reforming apparatus that can scavenge within the apparatus using air after stopping the introduction of the fuel stream.

2. Description of the Related Art

Conventionally, a reforming apparatus is known that provides a reformer in which a reformed gas that includes hydrogen is obtained by reacting a fuel stream that includes an alcohol such as methanol or hydrocarbons and water on a catalyst in a steam reforming reaction. In addition, a fuel cell system is also known in which a reformed gas that includes hydrogen obtained by a reforming apparatus and an oxidizing agent such as air are supplied to a fuel cell, and power is generated by an electrochemical reaction.

A base metal catalyst having copper as a main component is generally the reforming catalyst used in the reforming reaction.

In addition, in the case that a reformed gas is used as a hydrogen gas for a fuel cell, because the anode electrode of the fuel cell is poisoned by carbon monoxide, which causes a power loss in the fuel cells, the carbon monoxide must be eliminated from the reformed gas. Thus, a selective oxidizing apparatus is provided that uses a ruthenium selective oxidizing catalyst that is superior in selectively oxidizing carbon monoxide and oxidizes the carbon monoxide to carbon dioxide by this selective oxidizing reaction.

However, there are the drawbacks that in a reforming apparatus that uses a base metal catalyst as a reforming catalyst and a ruthenium type catalyst as a selective oxidizing catalyst, when the gas such as air that includes oxygen comes into direct contact with a catalyst by flowing into the apparatus during start-ups or stops, abnormal heat generation of the catalyst due to oxidizing and degradation of the capacity of the catalyst due to oxidation degradation occur.

Specifically, in the case of a base metal catalyst, as shown by the following formula (1), abnormal heat generation due to the oxidizing of copper and heat degradation of the catalyst due to this heat generation occur, and in the case of a ruthenium type catalyst, oxidation degradation due to oxidization as shown in the following formula (2) occurs.

Cu+1/2O₂→CuO (1)

Ru+1/2O₂→RuO (2)

In particular, while the operation of the reforming apparatus is stopped, the fuel stream and the hydrogen remaining in the apparatus at high temperature must be rapidly purged (scavenged) from the apparatus. The abnormal heating is suppressed while the catalyst is being completely cooled and inactivated, the length of time until the operation stop is made short, and in order to limit the degradation of the catalyst, air must not come into contact with the catalyst. In addition, because it is necessary prepare an inert gas tank and to provide an inert gas introducing device in the reforming apparatus, there has been the problem that the system becomes complex.

Furthermore, in a fuel cell vehicle having a reforming apparatus built in, compared to conventional gasoline internal combustion engine vehicles, there has been the problem that the system for stopping the operation of the vehicle has become complicated.

Thus, it is an object of the present invention to provide a reforming apparatus that can simplify the system for stopping the operation of the apparatus and limit the degradation of the catalyst without requiring an inert gas for scavenging, and a scavenging method for the reforming apparatus.

### SUMMARY OF THE INVENTION

In order to attain the object described above, the reforming system of the present apparatus is characterized in comprising a reformer that generates a hydrogen rich reformed gas from a fuel stream by a reforming reaction using a reforming catalyst, a fuel introducing device that can introduce the fuel stream into the reformer, and an air introducing device that can introduce air into the reformer, and wherein the reforming catalyst of the reformer is a noble metal catalyst carried by a metallic oxide.

In this type of structure, the noble metal catalyst, which acts as the reforming catalyst, is carried by a stable metallic oxide, and thus the actual amount of the catalyst is small in comparison to the conventional base metal catalyst, and the amount of heat generation due to oxidizing is minor. Furthermore, in comparison to the base metal catalyst, the noble metal catalyst has a high fusion point, and thus the heat degradation due to sintering that accompanies heat generation due to oxidization is minor. A noble metal catalyst carried by a metallic oxide in this manner does not generate abnormal heat even when it comes into contact with air, and thus the heat degradation is minor. Therefore, when scavenging inside the apparatus after the introduction of the fuel stream has stopped, air introduced from an air introducing device can be used in this scavenging.

In addition, the present invention is characterized in comprising a reformer that generates a hydrogen rich reformed gas from a fuel stream by a reforming reaction using a reforming catalyst, a fuel introducing device that can introduce the fuel stream into the reformer, a selective oxidizing apparatus that oxidizes the carbon monoxide in the reformed gas to carbon dioxide by a selective oxidizing reaction using a selective oxidizing catalyst, and an air introducing device that can introduce air into the reforming apparatus and/or into the selective oxidizing apparatus, and wherein the reforming catalyst of the reformer is a noble metal catalyst carried by a metallic oxide, and the selective oxidizing catalyst of the selective oxidizing apparatus is a catalyst that incorporates platinum.

In this type of structure, as described above, the noble metal catalyst carried by the metallic oxide does not generate abnormal heat even if it comes into contact with air, and the heat degradation is minor. Furthermore, in comparison to the conventional ruthenium catalyst, a catalyst incorporating platinum, which is a selective oxidizing catalyst, is highly resistant to oxidization degradation, and does not easily generate oxides. Thus, when scavenging the inside of the apparatus after stopping the introduction of the fuel stream, the air introduced from the air introducing device can be used in this scavenging.

In addition, a vaporizer is provided upstream of the reformer that vaporizes the fuel stream, and the air introducing device can use the air introduced from the air introducing device and heated by the evaporator when heating the downstream reformer. Thus, the same device can be used as the air introducing device for scavenging and the air introducing device for heating.

Furthermore, a scavenging method for the reforming apparatus of the present invention comprising a reformer that generates a hydrogen rich reformed gas from a fuel stream by a reforming reaction using a reforming catalyst, a fuel introducing device that can introduce the fuel stream into the reformer, and an air introducing device that can introduce air into the reformer, and wherein the reforming catalyst of the reformer is a noble metal catalyst carried by a metallic oxide, is characterized in comprising the steps of stopping the introduction of the fuel stream from the fuel introducing device and starting the introduction of air from the air introducing device after stopping the introduction of the fuel stream.

In this type of structure, as described above, because the reforming catalyst is a noble metal catalyst carried by a metallic oxide, the abnormal heat generation and heat degradation of the catalyst due to the air can be limited. Thus, when scavenging inside the apparatus after stopping the introduction of the fuel stream, the air introduced from the air introducing device can be used in the scavenging.

In addition, a scavenging method for a reforming apparatus comprising a reformer that generates a hydrogen rich reformed gas from a fuel stream by a reforming reaction using a reforming catalyst, a fuel introducing device that can introduce the fuel stream into the reformer, and a selective oxidizing apparatus that oxidizes the carbon monoxide in the reformed gas to carbon dioxide by a selective oxidizing reaction using a selective oxidizing catalyst, and an air introducing device that can introduce air into the reforming apparatus and/or into the selective oxidizing apparatus, and in which the reforming catalyst of the reformer is a noble metal catalyst carried by a metallic oxide, and the selective oxidizing catalyst of the selective oxidizing apparatus is a catalyst that incorporates platinum, is characterized in comprising the steps of stopping the introduction of the fuel stream from the fuel introducing device and starting the introduction of air from the air introducing device after stopping the introduction of the fuel stream.

In this type of structure, the reforming catalyst is a noble metal catalyst carried by a metallic oxide and furthermore the selective oxidizing catalyst is a catalyst that incorporates platinum, and thus abnormal heat generation, heat degradation, and oxidization degradation of the catalyst due to air can be limited. Thereby, the air introduced from the air introducing device can be used for scavenging when scavenging the inside of the apparatus after stopping the introduction of the fuel stream.

### BRIEF DESCRIPTION OF THE DRAWINGS

FIG. 1 is a schematic structures drawing showing an example of the reforming apparatus of the present invention.

FIG. 2 is a cross-sectional drawing showing an example of the reforming catalyst layer used in the reforming apparatus of the present invention.

FIG. 3 is a schematic structural drawing showing another example of the reforming apparatus of the present invention.

FIG. 4 is a schematic structural drawing showing another example of the reforming apparatus of the present invention.

FIG. 5 is a schematic structural drawing showing another example of the reforming apparatus of the present invention.

FIG. 6 is a schematic structural drawing showing an example of the fuel cell system in a fuel cell vehicle to which the reforming apparatus of the present invention is applied.

FIG. 7 is a graph showing the change over time of the reforming catalyst temperature after the start of air scavenging.

FIG. 8 is a graph showing the change over time of the reforming catalyst temperature after the start of nitrogen scavenging.

FIG. 9 is a graph showing the carbon monoxide-selective oxidizing capacity of the selective oxidizing catalyst as a function of the number of heat processes.

### DETAILED DESCRIPTION OF THE INVENTION

Below, embodiments of the present invention will be explained with reference to the figures.

First Embodiment

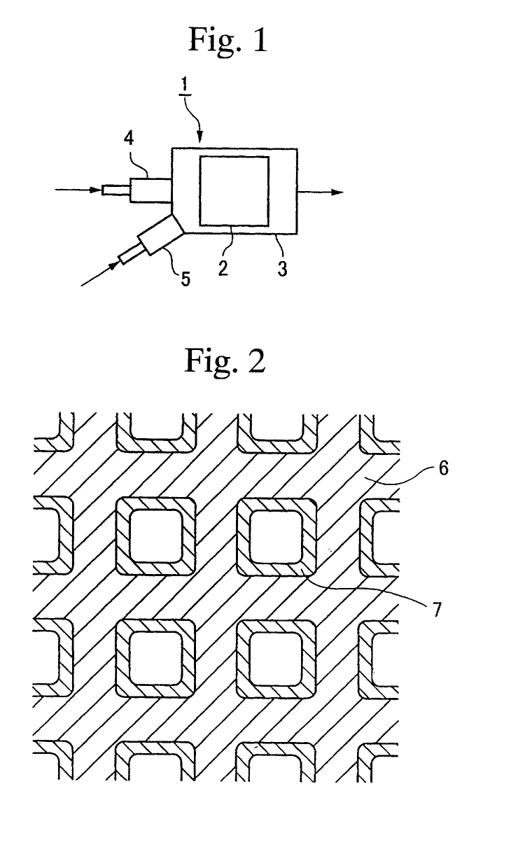

FIG. 1 is a schematic structural drawing showing an embodiment of the reforming apparatus of the present invention. This reforming apparatus 1 is a diagrammatic structure providing a reformer 3 that accommodates a reforming catalyst layer 2 comprising a reforming catalyst and generates a hydrogen rich reformed gas from the fuel stream by a reforming reaction using a reforming catalyst, a fuel introducing device 4 that can introduce the fuel stream into the reformer 3, and an air introducing device 5 that can introduce air into the reformer 3.

The reforming catalyst is a noble metal catalyst carried by a metallic oxide, and metals referred to as noble, such as the gold, silver, and platinum family (palladium, platinum, ruthenium, rhodium, osmium, and iridium) are noble metals that can be used as such a noble metal catalyst. These noble metals can be used singly, or a plurality of types can be combined. Among such noble metals, palladium and platinum, which have high reforming activity, are favorably used.

Zinc oxide (ZnO), aluminum oxide (alumina, Al₂O₃), silicon dioxide (silica, SiO₂), titanium oxide (TiO₂) or the like can be used as the metal oxide for the carrier. Among these, zinc oxide, which has a high steam reforming capacity, is preferable.

While not limited in particular, for example, forms in which particles of the noble metal catalyst can be bonded to the surface of the particles of the metal oxide can act as the metallic oxide for the noble metal catalyst.

While not limited in particular, for example, forms of the reforming catalyst 2 include the pellet type, in which the reforming catalyst is formed in a pallet shape, or, as shown in FIG. 2, the honeycomb type, in which a reforming catalyst 7 paste is coated on the surface of a honeycomb shaped monolith formation 6 having a plurality of holes machined into a ceramic or metal to produce a high surface area. Among these, a honeycomb type is preferable considering the point that the reforming reaction proceeds uniformly and efficiently.

The fuel introducing device 4 and the air introducing device 5 can be devices that can introduce the fuel stream or air into the reformer, and while not particularly limited, well-known injection apparatuses such as an injector, nozzle or the like, or a device in which the positive-pressure fuel stream is interrupted or released can be used.

The reforming of the fuel stream using the reforming apparatus 1 and the operation stop control of the reforming device 1 are carried out as follows.

First, the fuel stream introduced from the fuel introducing device 4 into the heated reformer 3 comes into contact with the reforming catalyst on the surface of the reforming catalyst layer 2 where it is subject to a reforming reaction, it is reformed into a hydrogen rich reformed gas, and this reformed gas is discharged from the reformer 3.

The operation stop control of the reforming apparatus 1 is carried out by starting the introduction of air from the air introducing device 5 after stopping the introduction of the fuel stream from the fuel introducing device 4, and then scavenging the fuel stream and the reformed gas in the reformer 3. While the reforming catalyst layer 2 is completely cooled and the reforming catalyst is inactivated, air is introduced from the air introducing device 5, and the scavenging inside the reformer 3 is carried out.

This fuel stream is a mixed stream comprising an alcohol or a hydrocarbon mixed with water, and normally is supplied to the reformer 3 in a vaporized state.

Methanol, ethanol or the like can be used as the alcohol, and normally methanol is used. Gasoline, methane, propane or the like can be used as the hydrocarbon.

The temperature of the reforming catalyst layer 2 during the reforming of the fuel stream is normally in a range of 300 to 800° C. While not particularly limited, for example, a method comprising introducing a small quantity of air from the air introducing device 5, burning a part of the alcohol or hydrocarbon in the fuel stream by combusting it with the oxygen in the air, and heating the reforming catalyst layer 2 can serve as the heating method (autothermal method) for the reforming catalyst layer 2.

In this type of reforming apparatus 1, because a noble metal catalyst carried by a metallic oxide is used as the reforming catalyst, even if air is used in scavenging during the operation stop control of the apparatus, abnormal heating of the reforming catalyst does not occur, and the cooling and inactivation of the reforming catalyst can be carried out in an amount of time equal to conventional scavenging using an inert gas. In addition, the heat degradation of the reforming catalyst is minor. The reason for this is thought to be as follows. Because the noble metal catalyst is carried by a thermally stable metal oxide, compared to the conventional base metal catalyst, the actual amount of catalyst is small, and thus the amount of heat due to oxidizing is small. Furthermore, the noble metal catalyst has a high melting point compared to a base metal catalyst, and thus heat degradation due to sintering or the like that accompanies heat generation due to oxidizing is minor. Because the noble metal catalyst carried on a metallic oxide in this manner does not cause abnormal heat generation even when it comes into contact with air and thus the thermal degradation is minor, when scavenging in the apparatus after stopping the introduction of the fuel stream, air that is simply and always obtainable from the vicinity of the reforming apparatus 1 is introduced by the air introducing device 5, and can be used in this scavenging.

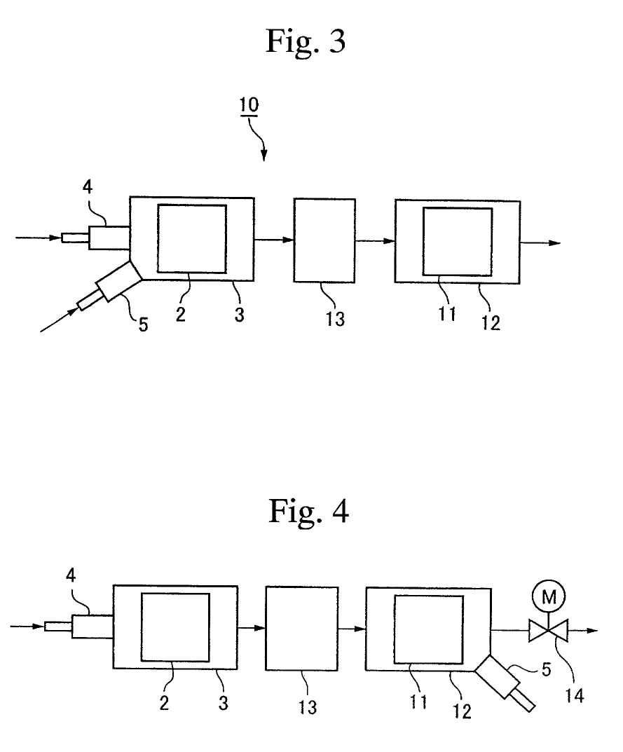

Second Embodiment FIG. 3 is a schematic structural drawing showing another embodiment of the reforming apparatus of the present invention. This reforming apparatus 10 is diagrammatically structured to provide a reformer 3 that accommodates a reforming catalyst layer 2 comprising a noble metal system reforming catalyst, and generates a hydrogen rich reformed gas from the fuel stream by a reforming reaction using a noble metal-system reforming catalyst, a fuel introducing device 4 can introduce a fuel stream into a reformer 3, an air introducing device 5 that can introduce air into the reformer 3, a selective oxidizing apparatus 12 that accommodates a selective oxidizing catalytic layer 11 comprising a selective oxidizing catalyst containing platinum and oxidizes the carbon monoxide in the reformed gas to carbon dioxide by a selective oxidizing reaction using a selective oxidizing catalyst, and a heat exchanger 13 that can lower the temperature of the reformed gas discharged from the reformer 3 to the temperature that allows introducing it into the selective oxidizing device 12.

A platinum catalyst or a catalyst that incorporates platinum can be used as the selective oxidizing catalyst. Carrying this selective oxidizing catalyst on the surface of a thermally stable metal oxidizer is preferable in consideration of limiting thermal degradation. Aluminum oxide (alumina, Al₂O₃), silicon dioxide (silica, SiO₂), titanium oxide (TiO₂) or the like can be used as the metallic oxide for the carrier. Among these, aluminum oxide is preferable in consideration of its high thermal stability and large surface area.

Although not limited in particular, for example, the selective oxidizing catalyst 11 can be a pellet type in a shape of pellet or a honeycomb type, as described above. Among these, the honeycomb type is preferable considering that the selective oxidizing reaction proceeds uniformly and efficiently.

The reforming of the fuel stream using this reforming apparatus 10 and the stopping of the operation thereof are carried out as follows.

First, the fuel stream introduced from the fuel introducing device 4 into the heated reformer 3 is brought into contact with the reforming catalyst of the reforming catalytic layer 2 surface, subject to a reforming reaction, and reformed into a hydrogen rich reformed gas. In the heat exchanger 13, this reformed gas is introduced into the selective oxidizing apparatus 12 after the temperature is lowered specifically to a range of 100 to 300° C., which allows its introduction into the selective oxidizing apparatus 12. A part of the carbon monoxide in the reformed gas introduced into the selective oxidizing apparatus 12 is oxidized to carbon dioxide at the selective oxidizing catalyst on the selective oxidizing catalytic layer 11 surface. In this manner, the reformed gas that has been subject to selective oxidation and thus has having a reduced concentration of carbon monoxide is discharged from the selective oxidizing apparatus 12.

The operation stop control of the reforming apparatus 10 is carried out by starting the introduction of air from the air introducing device 5 after stopping the introduction of the fuel stream from the fuel introducing device 4, and scavenging the fuel stream and reformed gas in the reformer 3, along with the reformed gas in the selective oxidizing apparatus 12. While the reforming catalytic layer 2 and the selective oxidizing catalyst layer 11 are being completely cooled and the reforming catalyst and the selective oxidizing catalyst are inactivated, air from the air introducing device 5 is introduced, and scavenging inside the reformer 3 and the selective oxidizing apparatus 12 is carried out.

In this type of reforming apparatus 10, because a noble metal catalyst carried by a metal oxide is used as the reforming catalyst, even if air is used in scavenging during the operation stop control of the apparatus, abnormal heat generation of the reforming catalyst does not occur, and the cooling and inactivation of the reforming catalyst can be carried out in actually the same amount of time as the scavenging by a conventional inert gas. In addition, thermal degradation of the reforming catalyst is minor.

In addition, because a catalyst that incorporates platinum is used as the selective oxidation catalyst, even if air is used in scavenging during the operation stop control of the apparatus, oxidation degradation of the selective oxidization catalyst occurs only with difficulty. The reason for this is believed to be that a catalyst that incorporates platinum is strongly resistant to oxidation degradation and generates oxides (PtO) with difficulty in comparison to the conventional ruthenium catalyst. Thus, even if the selective oxidizing catalyst comes into contact with air, oxidation degradation occurs with difficulty, and thus when scavenging inside the apparatus after stopping the introduction of the fuel stream, the air, which is simply and always obtainable from the vicinity of the reforming apparatus 10, is introduced by the air introducing apparatus and can be used in this scavenging.

Moreover, as shown in FIG. 4, the air introducing device 5 can be provided on the selective oxidizing apparatus 12 side. In this case, the valve 14 is provided downstream of the selective oxidizing apparatus 12, and during scavenging this valve is opened and closed, and air flows in the opposite direction. Thereby, scavenging inside the apparatus can be carried out. In addition, the air introducing device 5 can be provided on both the reformer 3 and the selective oxidizing device 12.

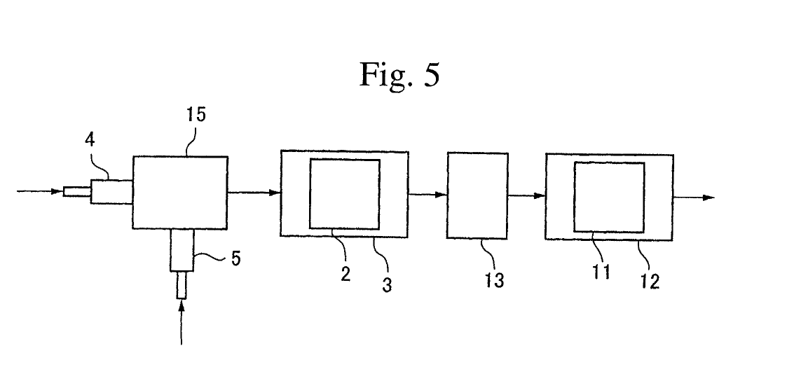

In addition, as shown in FIG. 5, the fuel introducing device 4 and the air introducing device 5 can be provided upstream of the reformer 3, and a vaporizer 15 for vaporizing the fuel stream can also be provided. Due to this type of structure, when the downstream reformer 3 is heated, the air introduced from the air introducing device 5 and heated by the vaporizer 15 can be used in the heater, and thus the same device can be used for the air introducing device 5 for scavenging and the air introducing device for heating, and thereby the apparatus can be simplified.

Third Embodiment

Next, an embodiment in which the reforming apparatus of the second embodiment is applied to a fuel cell vehicle will be explained with reference to the drawings.

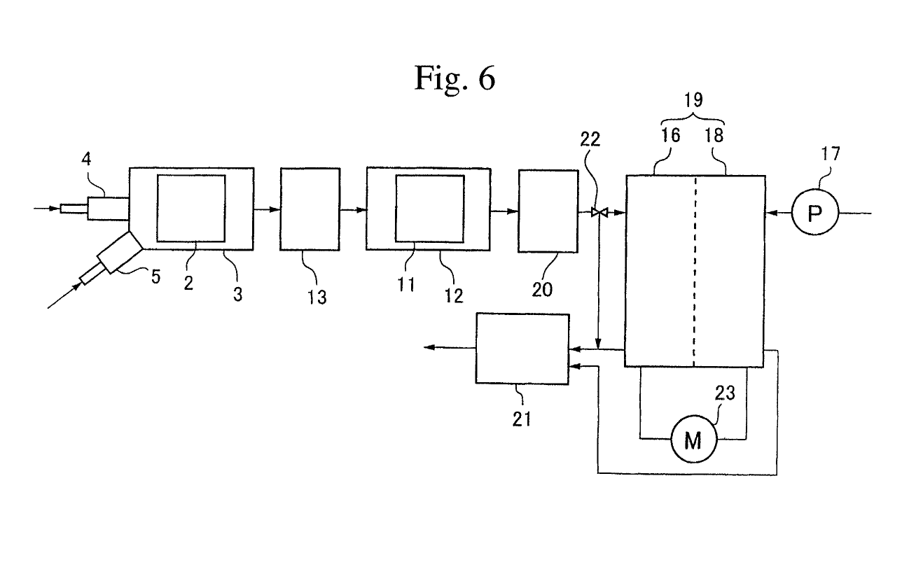

FIG. 6 is a schematic structural drawing of a fuel cell system showing an embodiment in which the reforming apparatus of the second embodiment is applied to a fuel cell vehicle.

This fuel cell system comprises a reformer 3 that accommodates a reforming catalytic layer 2 comprising a reforming catalyst and generates a hydrogen rich reforming gas from the fuel stream by a reforming reaction using the reforming catalyst, a fuel introducing device 4 that can introduce a fuel stream into the reformer 3, an air introducing device 5 that can introduce air into the reformer 3, a selective oxidizing apparatus 12 that accommodates a selective oxidizing catalytic layer 11 comprising a selective oxidizing catalyst and oxidizes carbon monoxide in the reformed gas to carbon dioxide by a selective oxidizing reaction using the selective oxidizing catalyst, a fuel cell 19 having an anode electrode 16 to which the reformed gas that has been selectively oxidized is introduced and a cathode electrode 18 into which air from the pump 17 is introduced, a heat exchanger 13 that lowers the temperature of the reforming gas discharged from the reformer 3 until it can be introduced into the selective oxidizing apparatus 12, a heat exchanger 20 that lowers the temperature of the selectively oxidized reformed gas discharged from the selective oxidizing apparatus 12 until it can be introduced into the fuel sell 19, and a burner 21 that burns the hydrogen and oxygen remaining in the off gas discharged from the fuel cell 19.

The power generation and operation stop control for using this fuel cell system is carried out as follows.

First, the fuel stream introduced from the fuel introducing device 4 into the heated reformer 3 is brought into contact with the reforming catalyst on the reforming catalytic layer 2 surface and subject to a reforming reaction, and reformed to a hydrogen rich reformed gas. After the temperature of this reformed gas is lowered in the heat exchanger 13 until it can be introduced into the selective oxidizing apparatus 12, it is introduced into the selective oxidizing apparatus 12. A part of the carbon monoxide in the reformed gas introduced into the selective oxidizing apparatus 12 is oxidized to carbon dioxide at the selective oxidizing catalyst on the selective oxidizing catalytic layer 11 surface.

After the temperature of the reformed gas selectively oxidized in this manner and having the concentration of carbon dioxide lowered in the heat exchanger 20 until it can be introduced into the fuel cell 19, specifically, lowered to a range between ambient temperature to 80° C., it is introduced into the anode electrode 16 side of the fuel cell 19.

In contrast, air is introduced as an oxidizing gas from the pump 17 on the cathode electrode 18 side of the fuel cell 19.

In the fuel cell 19, an electrochemical reaction occurs between the hydrogen in the reformed gas introduced at the anode electrode 16 side and the oxygen in the air introduced at the cathode electrode 18 side, and power is generated. The generated electricity is supplied to the motor 23 of the vehicle.

After being supplied for power generation, the reformed gas introduced at the anode electrode 16 side of the fuel cell 19 is discharged from the anode electrode 16 as off gas. In addition, the air that was introduced at the cathode electrode 18 side is discharged from the cathode electrode 18 as off gas after being supplied for power generation.

The off gas discharged from the fuel cell 19 is discharged after the hydrogen and oxygen remaining therein is burned in the burner 21.

The operation stop control of the fuel cell system is carried out by starting the introduction of air from the air introducing device 5 after stopping the introduction of the fuel stream from the fuel introducing device 4, and scavenging the fuel stream and the reformed gas in the reformer 3 and the reformed gas in the selective oxidizing apparatus 12. At this time, a three-way valve 22 provided between the heat exchanger 20 and the fuel cell 19 is switched, and discharge gas is introduced directly into the burner 21.

The reforming catalytic layer 2 and the selective oxidizing catalytic layer 11 are cooled, and which the reforming catalyst and the selective oxidizing catalyst are inactivated, air is introduced from the air introducing device 5and scavenging in the reformer 3 and the selective oxidizing apparatus 12 is carried out.

The scavenged gas scavenged from the reformer 3 and the selective oxidizing apparatus 12 is discharged after the fuel stream and hydrogen remaining in the burner 21 are burned by the oxygen in the air.

Moreover, the high temperature burned gas discharged from the burner 21 is supplied to a vaporizer (not illustrated) and can be used as a heat source for vaporizing the fuel stream.

In addition, the air introduced from the air introducing device 5 is used after being separated from the air from the pump 17.

In this type of fuel cell system, because a noble metal catalyst carried by a metal oxide is used as a reforming catalyst, even if air is used in scavenging during the operation stop control of the apparatus, abnormal heat generation by the reforming catalyst does not occur, and the cooling and inactivation of the reforming catalyst can be carried out in an amount of time equal to conventional scavenging using an inert gas. In addition, the thermal degradation of the reforming catalyst is minor.

In addition, because the catalyst incorporating platinum is used as a selective oxidizing catalyst, even if air is used as a scavenger during the operation stop control of the apparatus, oxidation degradation of the selective oxidizing catalyst occurs with difficulty. In this manner, even if the reforming catalyst comes into contact with air, because abnormal heat generation does not occur and oxidation degradation occurs with difficulty, when scavenging the inside of the apparatus after stopping the introduction of the fuel stream, the air that can be simply and always obtained from the vicinity of the reforming apparatus 10 is introduced by the air introducing device 5, and can be used in this scavenging.

### EXAMPLES

Below, the present invention will be explained in further detail using an example.

(Preparation of a copper reforming catalyst)

Copper nitrate, zinc nitrate, and aluminum nitrate are mixed with and dissolved in water at a metal atomic ratio of 1.3:1.0:0.02, to make a 5 mol % aqueous solution. While being heated to 50° C., a sodium hydrogencarbonate 5 mol % aqueous solution is dripped, and a coprecipitate is obtained. After the coprecipitate is washed and dried, it is calcined for 2 hours in air at 400° C., and a carbon catalytic powder is obtained. This catalytic powder, an appropriate amount of alumina sol, and water are mixed, the compound is crushed by a ball mill, and a catalytic slurry obtained. A cordierite honeycomb is immersed in this catalytic slurry, and the catalytic slurry is carried on the surface of the cordierite honeycomb. After during this, it is calcined at 400° C., and made into a test sample.

(Preparation of a noble reforming catalyst)

Dinitrodianmine palladium and zinc oxide were mixed with and dissolved in water at a metal atomic ratio of 1:9, to make a palladium 5 mol % aqueous solution. While being heated to 50° C., a palladium 5 mol % aqueous solution was dripped, and a coprecipitate was obtained. After the coprecipitate was washed and dried, it was calcined for 2 hours in air at 400° C., and a noble metal catalytic powder was obtained. This catalytic powder, an appropriate amount of alumina sol, and water were mixed, the compound was crushed by a ball mill, and a catalytic slurry was obtained. A cordierite honeycomb was immersed in this catalytic slurry, and the catalytic slurry was carried on the surface of the cordierite honeycomb. After during this, it is calcined at 400° C., and made into a test sample.

(Preparation of the ruthenium selective oxidizing catalyst)

Ruthenium chloride and γ-alumina powder are mixed with and dissolved in water so as to obtain a Ru:Al₂O₃ ratio of 5 mol %, to obtain an aqueous solution suspension. After adjusting the pH of the aqueous solution to 8, while being heated to 50° C., a separately prepared 1.5 mol % NaBH₄ aqueous solution is dripped, and the ruthenium is reduced. After the drip has completed, it is washed and dried, and a ruthenium catalytic powder is obtained. This catalytic powder, an appropriate amount of alumina sol, and water are mixed, the compound is crushed by a ball mill, and a catalytic slurry obtained. A cordierite honeycomb was immersed in this catalytic slurry, and the catalytic slurry was carried on the surface of the cordierite honeycomb. After during this, it was calcined at 150° C., and made into a test sample.

(Preparation of the platinum selective oxidizing catalyst)

Platinate chloride and γ-alumina powder were mixed with and dissolved in water so as to obtain a Pt:Al₂O₃ ratio of 5 mol %, to obtain a aqueous solution suspension. After adjusting the pH of the aqueous solution to 8, while being heated to 50° C., a separately prepared 1.5 mol % NaBH₄ aqueous solution was dripped, and the ruthenium was reduced. After the drip completed, it was washed and dried, and a ruthenium catalytic powder was obtained. This catalytic powder, an appropriate amount of alumina sol, and water are mixed, the compound was crushed by a ball mill, and a catalytic slurry obtained. A cordierite honeycomb was immersed in this catalytic slurry, and the catalytic slurry is carried on the surface of the cordierite honeycomb. After during this, it was calcined at 150° C., and made into a test sample.

### Example 1

(Stop test of the reforming catalyst)

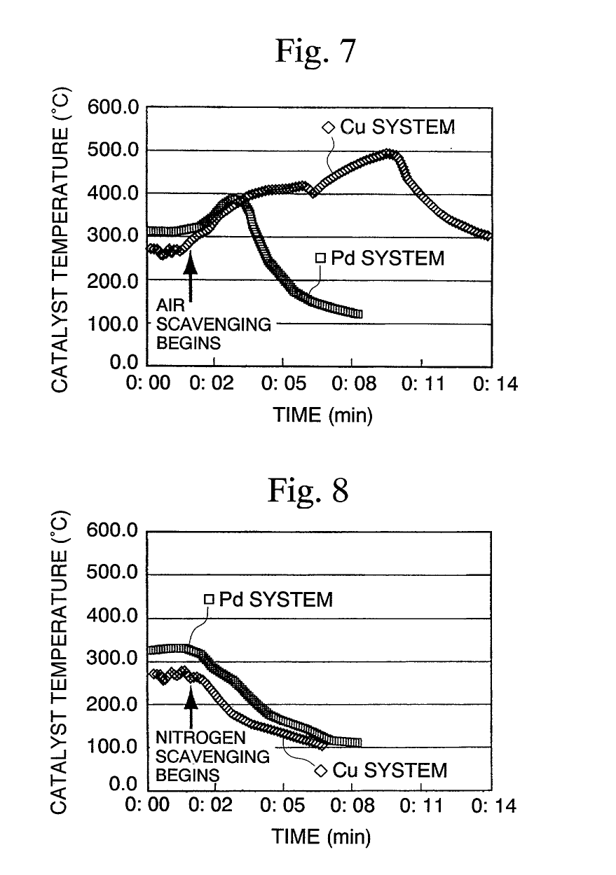

The reforming of methanol was carried out using the noble metal reforming catalytic layer under the following operating conditions. After the introduction of water and methanol was stopped, the temperature change of the catalyst while the inside of the reformer is being scavenged and the time required for operation stop control were measured. The results were shown in FIG. 7. In addition, for reference, the stop test was similarly carried out using nitrogen instead of air. The results are shown in FIG. 8.

(Test conditions)

Catalytic layer specifications: φ45 mm×20 mm; 400 cells, cordierite honeycomb; and catalyst carrier amount 200 g/L.

Operating conditions until the operation stop control: water/ethanol mixture ratio S/C=1.5 (vapor/carbon mol ratio); methanol LHSV (liquid hourly space velocity)=1; noble metal catalyst temperature=330° C.; reform rate (=1−[CH₃OH]/[CO₂]+[CO]+[CH₃OH]):99% or greater.

Stop conditions: the introduction of water and methanol is stopped, air (or nitrogen) is introduced at 0.6 L/sec to scavenge, the temperature change of the catalyst is observed, and the time required until operation stop is estimated.

### Comparative Example 1

(Stop test for the reforming catalyst)

The copper reforming catalytic layer described above was used and the copper catalyst temperature was changed to 280° C. Otherwise, the stop test was carried out under the same conditions as example 1.

In the scavenging using the nitrogen gas carried out for reference, as shown in FIG. 8, it can be understood that the noble metal reforming catalyst and the copper reforming catalyst were both cooled to 200° C. or lower in 4 minutes after stopping the introduction of water and methanol.

In contrast, in scavenging using air, while the noble metal reforming catalyst is cooled to 200° C. or less in approximately 5 minutes, the abnormal heat generation by the copper reforming catalyst was severe, and thus a long time is required to cool it to 200° C. or less.

Moreover, even in the noble metal reforming catalyst, a slight heat generation occurs immediately after the start of the air scavenging, but this is thought to be heat generation due to the oxidizing of the methanol remaining on the catalyst surface.

In the copper reforming catalyst, it has been confirmed that the heat generation occurs in two stages. It is supposed that the heat generation of the first stage is the heat generated due to the oxidation of residual methanol, and the second stage is heat generation due to oxidizing of the copper.

### Example 2

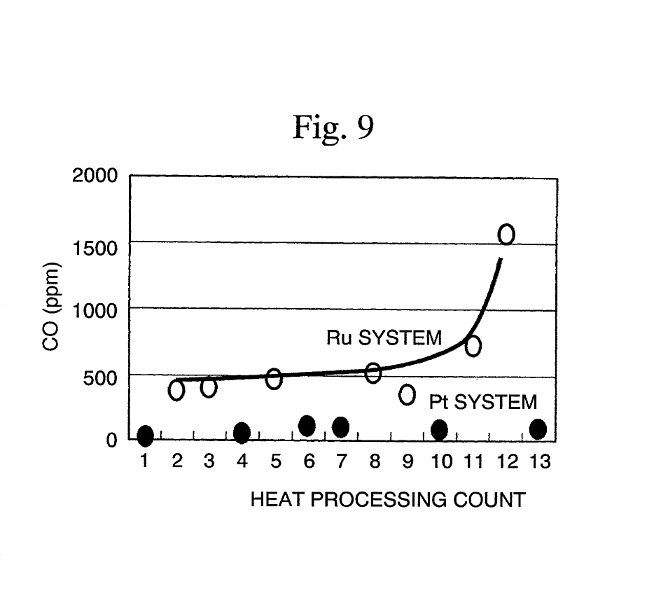

The platinum reforming catalytic layer described above was used, and the relation between the course of the oxidation resistance and the selective oxidizing capacity in the following test method. The results are shown in FIG. 9.

(Test method)

After the platinum reforming catalytic layer was heat processed for 1 hour in an air atmosphere at 160° C., the following test gas was selectively oxidized under the following conditions, and the carbon monoxide concentration in the selectively oxidized test gas was measured. This operation was repeated, and the change of the selective oxidizing capacity in an oxidizing atmosphere was examined.

Gas composition of the test gas: the reform gas and air were mixed such that H₂ 42 vol. %; CO 6500 ppm; CO₂ 17 vol. %; H₂ 20 vol. %; O₂/CO=1.5 (volume ratio).

Selective oxidizing conditions: SV=2000; catalyst temperature 140° C.

### Comparative Example 2

The ruthenium selective oxidizing catalytic layer described above was used. Otherwise, the stop test was carried out under the same conditions as example 2.

The ruthenium selective oxidizing catalyst was subjected to heat processing several times, and it is understood that the carbon monoxide selective oxidizing capacity was lost, and that the carbon monoxide concentration gradually increased.

In contrast, even when the platinum selective oxidizing catalyst had been subject to heat processing several times, it was understood that the carbon monoxide did not increase, and the oxidation resistance was superior.

From the results of he embodiments described above, by using a noble metal catalyst as the reforming catalyst, and furthermore, by using a platinum catalyst as a selective oxidizing catalyst, even if scavenging is carried out using air during the operation stop control of the reforming apparatus, lengthening of the time until the operation stop due to abnormal heat generation of the catalyst and oxidation degradation of the catalyst can be avoided.

As explained above, the reforming apparatus of the present invention uses a noble metal catalyst as the reforming catalyst, and thus abnormal heat generation and heat degradation of the reforming catalyst due to the air can be limited. Thereby, after the introduction of the fuel stream has stopped, the air introduced from the air introducing device can be used for scavenging inside the apparatus, and an inert gas does not have to be used during scavenging. In addition, thereby, because an inert gas tank and an inert gas introducing device are not necessary, the system for operation stopping is simplified.

In addition, the reforming apparatus of the present invention uses a noble metal catalyst as a reforming catalyst, and furthermore, uses a catalyst that incorporates platinum as a selective oxidizing catalyst, and thus abnormal heat generation and heat degradation of the reforming catalyst due to air, and oxidation degradation of the selective oxidizing catalyst can be limited. Thereby, after the introduction of the fuel stream has stopped, the air introduced from the air introducing device can be used for scavenging inside the apparatus, and an inert gas does not have to be used during scavenging. In addition, thereby, because an inert gas tank and an inert gas introducing device are not necessary, the system for operation stopping is simplified.

In addition, a vaporizer that vaporizes the fuel stream upstream to the reformer is provided, and due to the structure providing this vaporizer, the air introducing device can act both as an air introducing device for scavenging and an air introducing device for heating, and thus the system is further simplified.

In addition, in the scavenging method of the reforming apparatus of the present invention, a noble metal catalyst is used as the reforming catalyst, and thus abnormal heat generation and heat degradation of the reforming catalyst due to air can be limited. Thereby, after the introduction of the fuel stream has stopped, the air introduced from the air introducing device can be used for scavenging inside the apparatus, and an inert gas does not have to be used during scavenging. In addition, thereby, because an inert gas tank and an inert gas introducing device are not necessary, the system for operation stopping is simplified.

In addition, in the scavenging method of the reforming apparatus of the present invention, a noble metal catalyst is used as the reforming catalyst, and furthermore, a catalyst incorporating platinum is used as a selective oxidizing catalyst, and thus abnormal heat generation and heat degradation of the reforming catalyst due to air and oxidizing degradation of the selective oxidizing catalyst can be limited. Thereby, after the introduction of the fuel stream has stopped, the air introduced from the air introducing device can be used for scavenging inside the apparatus, and an inert gas does not have to be used during scavenging. In addition, thereby, because an inert gas tank and an inert gas introducing device are not necessary, the system for operation stopping is simplified.

What is claimed is:

1. A reforming apparatus comprising:
a reformer that generates a hydrogen rich reformed gas from a fuel stream by a reforming reaction using a reforming catalyst;
a fuel introducing device that can introduce said fuel stream into said reformer; and
an air introducing device that can introduce air into said reformer; and wherein:
the reforming catalyst of said reformer is a noble metal catalyst carried by a metallic oxide.

2. A reforming apparatus comprising:
a reformer that generates a hydrogen rich reformed gas from a fuel stream by a reforming reaction using a reforming catalyst;
a fuel introducing device that can introduce said fuel stream into said reformer;
a selective oxidizing apparatus that oxidizes the carbon monoxide in said reformed gas to carbon dioxide by a selective oxidizing reaction using a selective oxidizing catalyst; and
an air introducing device that can introduce air into said reformer and/or into said selective oxidizing apparatus; and wherein:
the reforming catalyst of said reformer is a noble metal catalyst carried by a metallic oxide; and
the selective oxidizing catalyst of said selective oxidizing apparatus is a catalyst that incorporates platinum.

3. A reforming apparatus according to claim 1 or claim 2 wherein:
a vaporizer is provided upstream of said reformer that vaporizes the fuel stream; and
said air introducing device is provided in said vaporizer.

4. A scavenging method for the reforming apparatus comprising a reformer that generates a hydrogen rich reformed gas from a fuel stream by a reforming reaction using a reforming catalyst, a fuel introducing device that can introduce said fuel stream into said reformer, and an air introducing device that can introduce air into said reformer, and in which the reforming catalyst of said reformer is a noble metal catalyst carried by a metallic oxide, comprises the steps of:
stopping the introduction of said fuel stream from said fuel introducing device; and
starting the introduction of air from said air introducing device after stopping the introduction of said fuel stream

5. A scavenging method for a reforming apparatus comprising a reformer that generates a hydrogen rich reformed gas from a fuel stream by a reforming reaction using a reforming catalyst, a fuel introducing device that can introduce said fuel stream into said reformer, and a selective oxidizing apparatus that oxidizes the carbon monoxide in said reformed gas to carbon dioxide by a selective oxidizing reaction using a selective oxidizing catalyst, and an air introducing device that can introduce air into said reforming apparatus and/or into said selective oxidizing apparatus, and in which the reforming catalyst of said reformer is a noble metal catalyst carried by a metallic oxide, and the selective oxidizing catalyst of said selective oxidizing apparatus is a catalyst that incorporates platinum, comprises the steps of:
stopping the introduction of said fuel stream from said fuel introducing device; and
starting the introduction of air from said air introducing device after stopping the introduction of said fuel stream.
